(19) United States
(12) Patent Application Publication
(10) Pub. No.: US 2011/0174030 A1
(43) Pub. Date: Jul. 21, 2011

(54) Lock Mechanism

(75) Inventors: John Rogers, Birmingham (GB); Andrew Middlebrook, Wednesbury (GB)

(73) Assignee: AVOCET HARDWARE LIMITED, Brighouse (GB)

(21) Appl. No.: 13/001,342

(22) PCT Filed: Jun. 25, 2009
(86) PCT No.: PCT/GB2009/001592

§ 371 Date: Mar. 25, 2011

(30) Foreign Application Priority Data
Jun. 26, 2008 (GB) 0811762.4

(51) Int. Cl. E05B 27/00

(52) U.S. Cl. 70/490

(57) ABSTRACT

A cylinder lock (100) having a first actuator assembly (102) and a second actuator assembly (106) positioned either side of a cam (132), in which the first and second actuator assemblies (102, 106) can selectively actuate the cam (132) by means of a clutch (142, 150) movable between two conditions and in which removal of the first actuator assembly (102) causes the clutch to move into a third, locked condition in which it is constrained. A cylinder lock (100) having a predetermined weakened area on the first actuator side of a cam.

The present invention relates to a lock mechanism. More specifically, the present invention relates to a lock mechanism for a cylindrical lock of a door.

Various types of locks exist. One of the most common types is a cylinder lock. Cylinder locks commonly contain a locking mechanism which prevents unauthorised opening of closures by extending a bolt from the closure into a corresponding keep on a frame surrounding the closure when in a closed position. Various types of locking mechanisms exist, for example those which require a key, e.g. pin tumbler mechanisms, wafer tumbler mechanisms and simple manual controls such as thumb bolt.

Cylinder locks commonly extend through the thickness of a closure to allow access and control of the locking mechanism from both sides. It may be the case therefore that a thumb bolt exists on the interior side of the closure to allow easy opening from the inside, whereas a pin tumbler exists on the exterior side allowing access only to those with a key.

The present invention is primarily concerned with euro-profile lock cylinders with key-lock mechanisms on both sides. Such cylinders are generally circular in cross-section with a radial protrusion.

In conventional cylinder locks, a cam is positioned approximately midway through the closure thickness within a locking assembly. The cam is rotatable and defines a lever projecting radially therefrom. The lever can only be aligned with the radial protrusion of the euro-profile cylinder cross section when the lock cylinder is fitted with a key (i.e. not secure). When in the locked condition, the cam is in a rotated position with the lever projecting out of alignment with the radial protrusion such that the lock cylinder cannot be removed. The cam is connected to a lock bolt projecting from the locking assembly such that rotation of the cam in a first direction causes the cam to retract the lock bolt to open the closure.

In order to provide the ability to open the closure from both sides, the cam is selectively connected to locking mechanisms on both sides (i.e. the interior and the exterior) of the closure. These connections are brought about by a clutch, which is axially slidable along the cylinder between a first position in which it forms a load path between the interior locking mechanism and the cam, and a second position in which it forms a load path between the exterior locking mechanism and the cam.

Therefore when the clutch is in the first position it can move freely with respect to the exterior side, and when it is in the second position is can move freely with respect to the interior side. In other words, the clutch only ever forms a load path between one of the locking mechanisms and the cam.

This arrangement is useful in situations in which, for example, a pin tumbler mechanism is provided on either side of the cam. If the clutch engaged both pin tumbler mechanisms, the user would have to insert keys from either side simultaneously to open the closure, which is clearly undesirable. In reality, the clutch is often positioned by abutment with the end of the key.

Often, the clutch has a default position to which it is biased unless urged to the other condition by e.g. the insertion of a key. In many cases, especially when the interior locking mechanism is a thumb bolt, the clutch is biased into the first position by a spring. Therefore the user can easily open the closure by simply turning the thumb bolt.

A problem with known locks of the type described above is that they can be broken into and the bolt actuated with relative ease. The application of force with a tool (for example a screwdriver, mole grips or wrench) from the exterior side can break away components of the cylinder lock leaving the bolt mechanism exposed and hence allowing unauthorised manipulation of the bolt and potentially opening of the closure.

Forced deformation of the outer cylinder results in a break at the point at which the lock is mounted (naturally the weakest point) which is also in the cam section. As the break occurs, the outer cylinder can be pulled away, and the now unconstrained clutch and cam components can be removed or pushed or fall out of the way to expose the lock mechanism. The geometry of the cam means that in many cases it can be rocked and pivoted within the assembly to be freed, providing access to the bolt mechanism.

It is an object of the above invention to provide an improved lock mechanism.

According to a first aspect of the present invention there is provided cylinder lock comprising:
a lock mechanism,
a lock cam actuable to unlock the lock mechanism,
a first lock actuator assembly positioned on a first side of the lock cam,
a second lock actuator assembly positioned on a second side of the lock cam, the second side being substantially opposite the first side,
a clutch defining an axis, the clutch being movable along the axis between:
   a first condition in which the clutch provides a rotational force path from the first actuator to the lock cam to lock or unlock the lock mechanism,
   a second condition in which the clutch provides a rotational force path from the second actuator to the lock cam to lock or unlock the lock mechanism, and
   a third condition in which the clutch is not movable along the axis, and
further comprising a security mechanism configured to put the clutch into the third condition upon removal of a component of the lock mechanism.

By making the clutch lock in an axial position, it is made more difficult to tamper with and more difficult to remove.

Preferably the component is the first lock actuator assembly.

Preferably the lock comprises a resilient member arranged to bias the clutch towards the third condition, in which the component has an operative position in which it is intact with the lock mechanism and when in such operative position forms an abutment which constrains the clutch from moving to the third condition.

Preferably the clutch comprises a first actuator of the first actuator assembly and a second actuator of the second actuator assembly, in which removal of the first actuator actuates the clutch to move to the third condition in the second actuator assembly.

Preferably the first and second actuators abut and the second actuator is biased towards the first actuator into the second condition, such that removal of the first actuator allows the second actuator to move to an overtravel position representing the third condition.

Preferably in the third condition the clutch is rendered immobile along the axis by a mechanical locking mechanism.

Preferably the mechanical locking mechanism comprises a resiliently biased member arranged to engage the second actuator when the second actuator is in the overtravel position.

Preferably in the third condition, the clutch provides a force path from the second actuator to the cam to unlock the lock mechanism.

Preferably an anti-drill component is provided on one of the cam and clutch and is configured to be at least partially exposed upon removal of the component of the lock mechanism.

The anti-drill component may comprise a pin mounted to the clutch and aligned with the axis. Preferably in the third condition the pin penetrates the cam to be exposed to a first lock actuator side of the cam.

The anti-drill component may comprise a plate attached to a first lock actuator side of the cam.

Preferably the anti-drill component comprises a hardened steel component.

Preferably the lock cam comprises:
a radially projecting cam lever, and,
an interior abutment surface which abuts the clutch in the third condition,
wherein a distance between the interior abutment surface and the second side of the lock cam is greater than a distance between the first side of the lock cam and the radially projecting cam lever.

Preferably a width of the cam lever is substantially equal to a width of the locking mechanism interior such that a rotational degree of freedom of the main axis is reduced.

Preferably the width of the lock cam is 1 to 8 mm less than the width of the locking mechanism interior. In this manner, forced rotation of the cam to remove it from the assembly is made more difficult.

According to a second aspect of the invention there is provided a lock assembly comprising:
a cylinder lock comprising a cam rotatable about a main axis,
a locking mechanism comprising a through passage to receive the cylinder lock, the locking mechanism having an interior actuation region in which the cam can actuate, the interior actuation region having a width in a direction substantially parallel to the main axis,
in which the width of the lock cam is substantially equal to the width of the locking mechanism interior such that a rotational degree of freedom of the main axis is reduced.

According to a third aspect of the invention there is provided a cylinder lock comprising:
a lock cam assembly comprising a lock cam actuable to lock or unlock a lock mechanism,
a first lock actuator assembly positioned on a first side of the lock cam,
a second lock actuator assembly positioned on a second side of the lock cam, the second side being substantially opposite the first side,
in which a weakened area of the cylinder lock is defined on, or on the first lock actuator side of, an interface between the first lock actuator and the lock cam.

Preferably the weakened area comprises a locally thinned or scored section of material.

Preferably the lock comprises a fastener arranged to fasten the first lock actuator assembly to the lock cam assembly, in which the weakened area is defined on the fastener.

Preferably the lock comprises a fastener comprising:
a first actuator mounting arm for attachment to the first lock actuator,
a second actuator mounting arm for attachment to the second lock actuator,
a central mounting portion for attachment of the cylinder lock to a lock mechanism,
wherein the weakened area is defined on the fastener between the first actuator mounting arm and the central mounting portion.

Preferably the weakened area comprises an interface between two components of an assembly.

Advantageously, provision of such a weakened area means that an attempted forced entry will merely remove the first lock actuator, and leave the cam in place thus preventing access to the interior of the locking mechanism.

An example lock mechanism will now be described with reference to the accompanying figures in which:

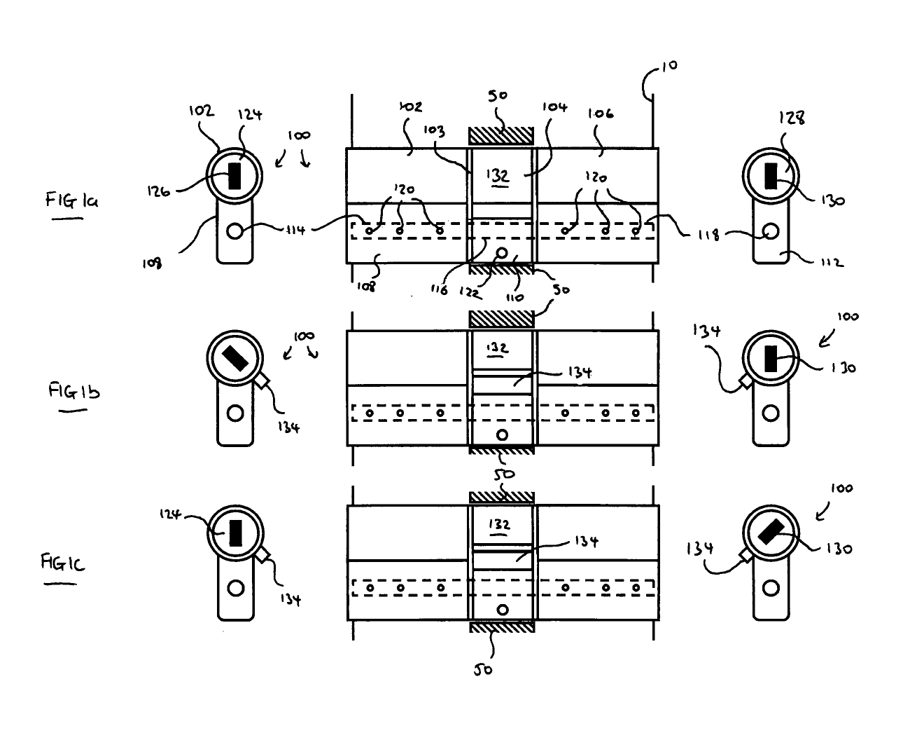

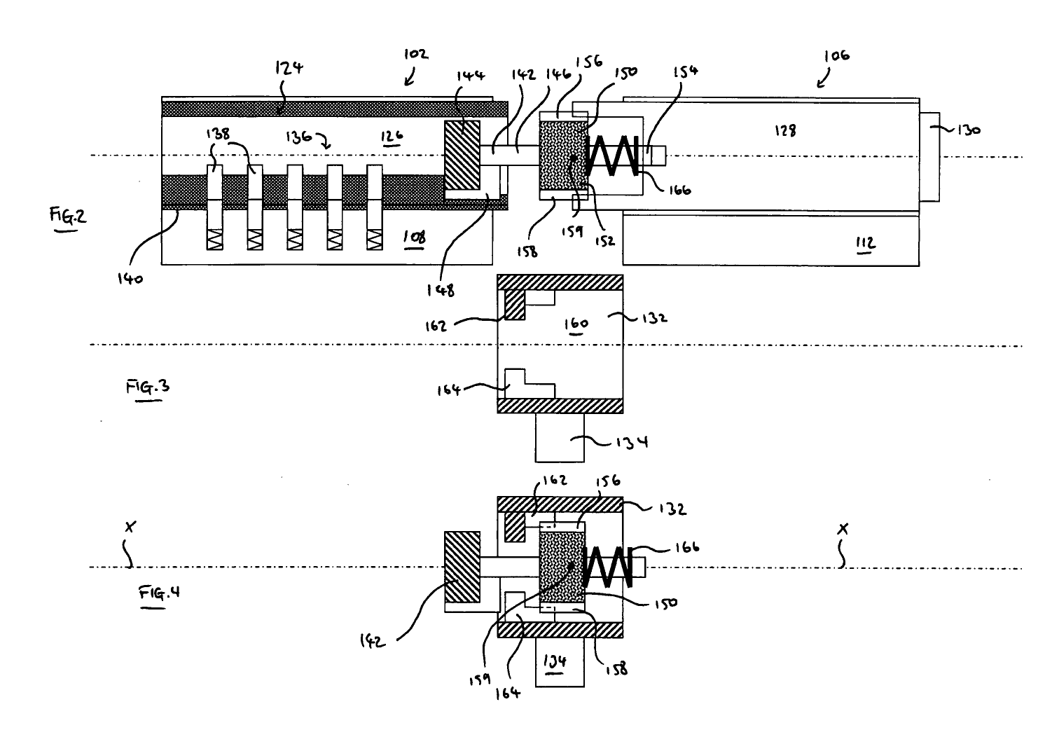

FIGS. 1a to 1c are external elevations of a double lock cylinder in accordance with the present invention,

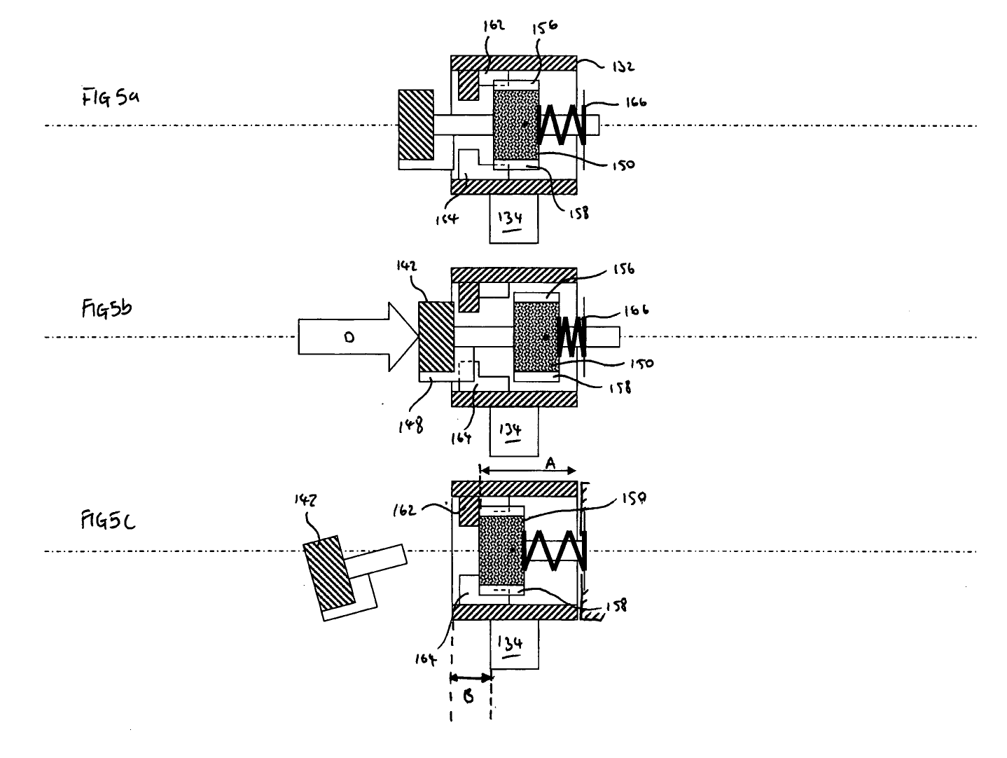

FIG. 2 is a schematic side section view of part of the lock cylinder of FIGS. 1a to 1c,

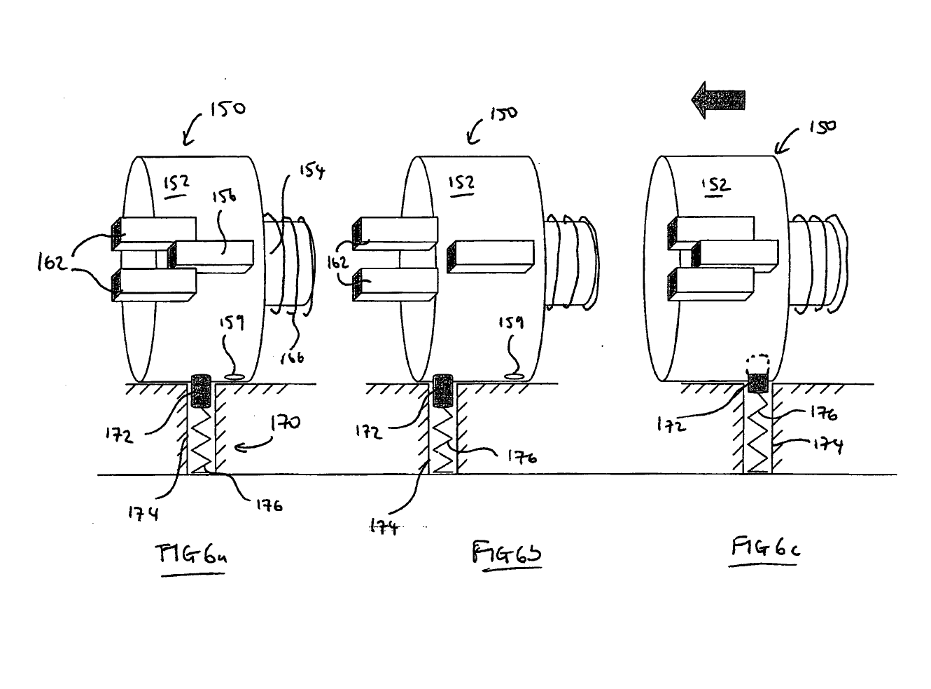

FIG. 3 is a schematic side section view of a further part of the lock cylinder of FIGS. 1a to 1c,

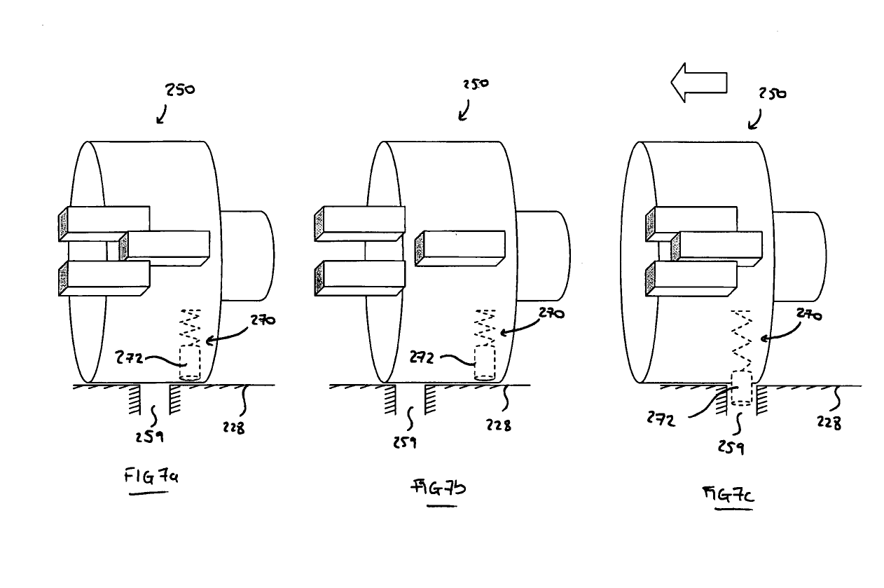

FIG. 4 is a schematic side section view of part of the lock cylinder of FIGS. 1a to 1c showing the interaction between features shown in FIGS. 2 and 3,

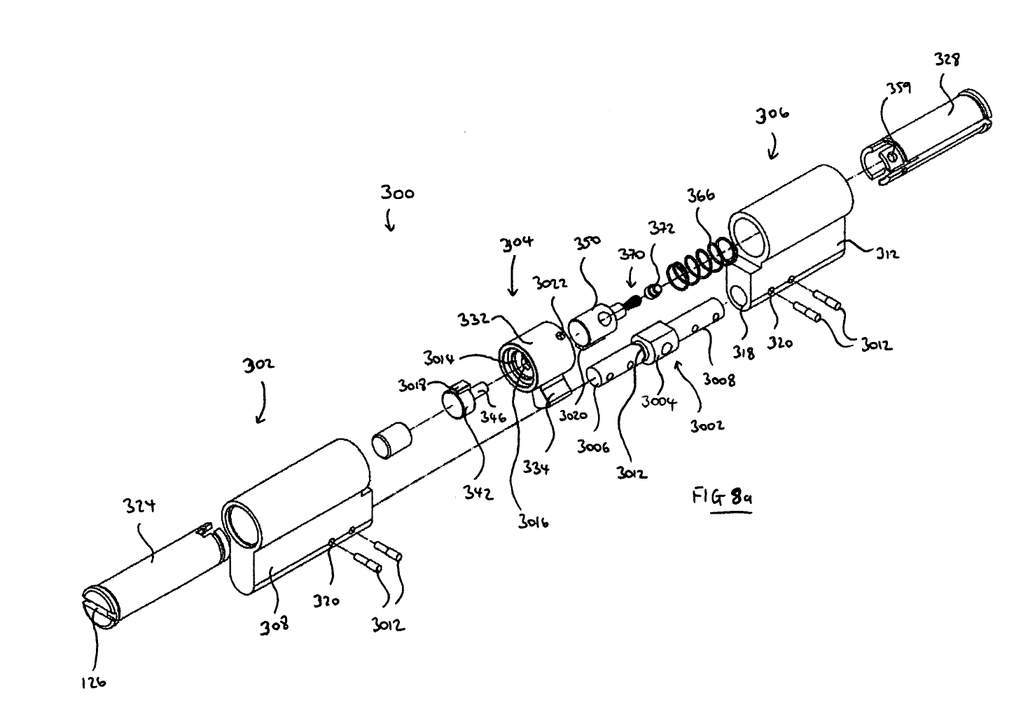

FIGS. 5a to 5c show a sequence of operation of the lock cylinder of FIGS. 1a to 1c,

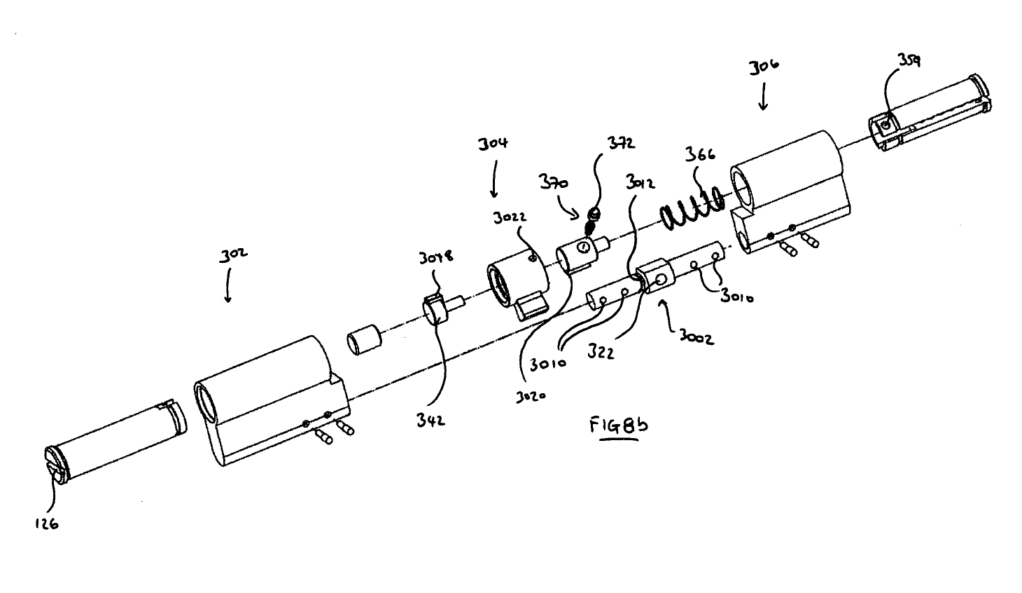

FIGS. 6a to 6c show a sequence of operation of a part of the lock cylinder of FIGS. 1a to 1c corresponding to the sequence of 5a to 5c,

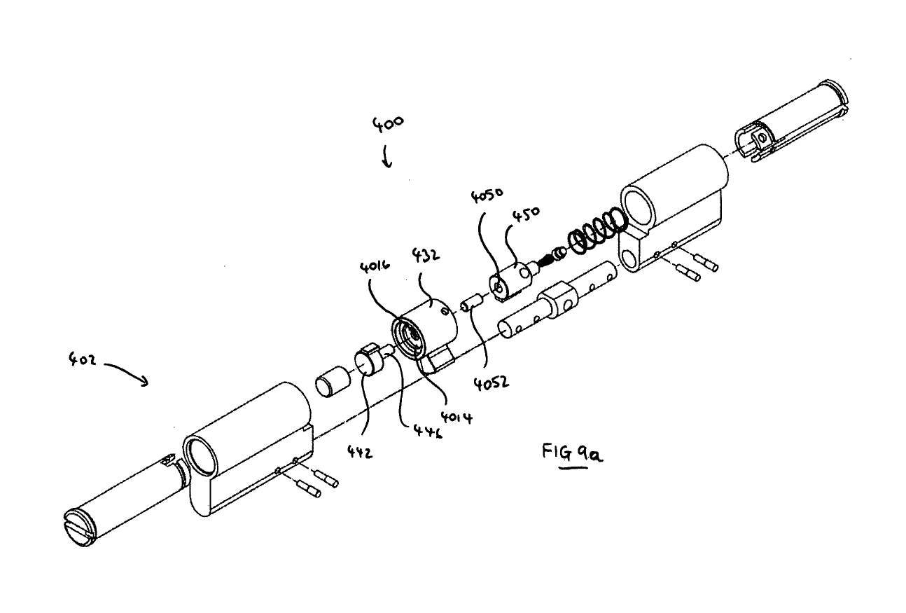

FIGS. 7a to 7c show a sequence of operation of a part of a second lock cylinder in accordance with the present invention,

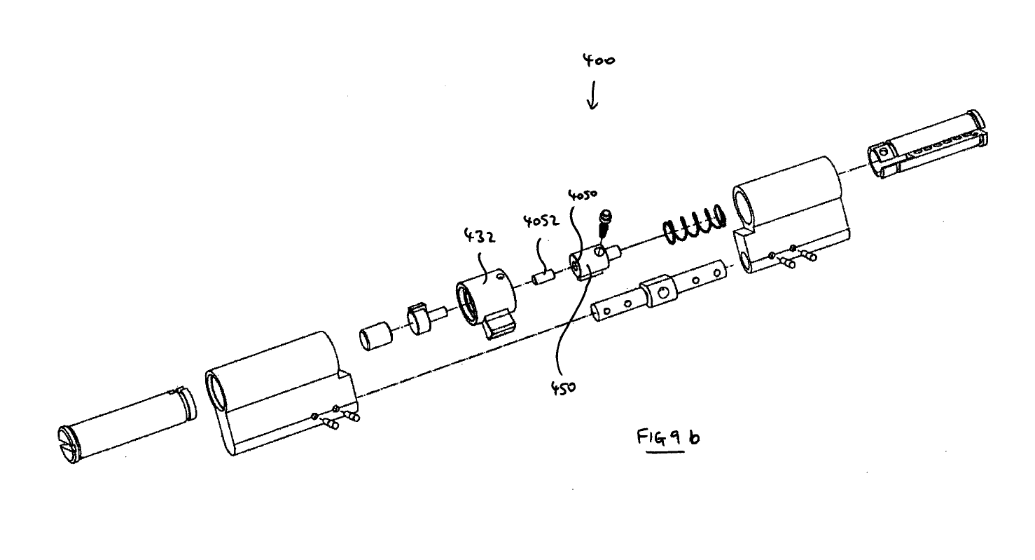

FIGS. 8a and 8b are exploded perspective views of a third lock cylinder in accordance with the present invention,

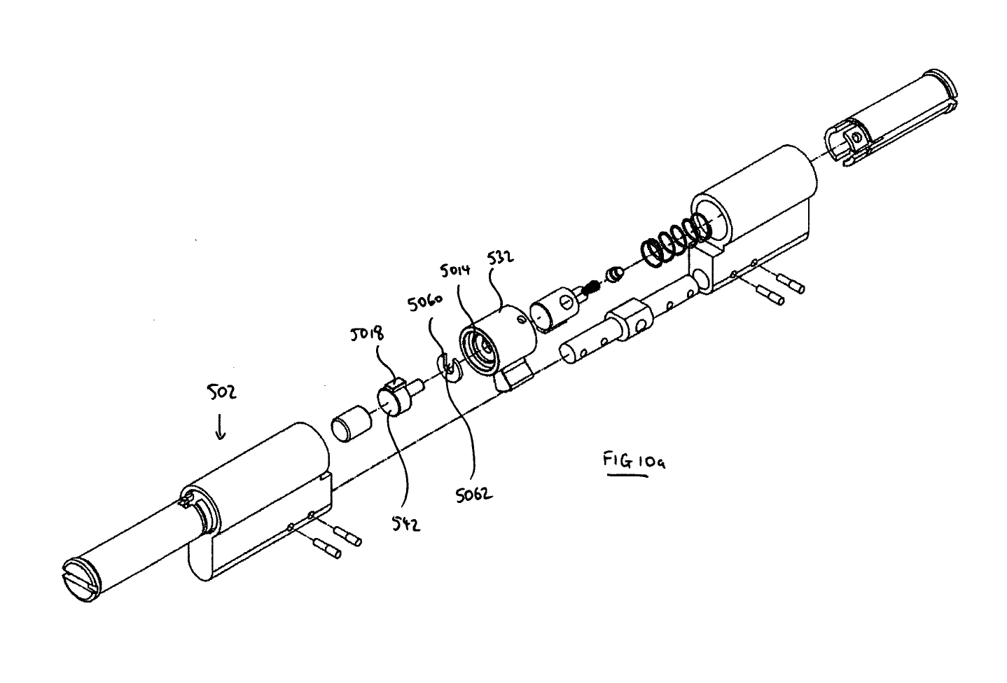

FIGS. 9a and 9b are exploded perspective views of a fourth lock cylinder in accordance with the present invention, and,

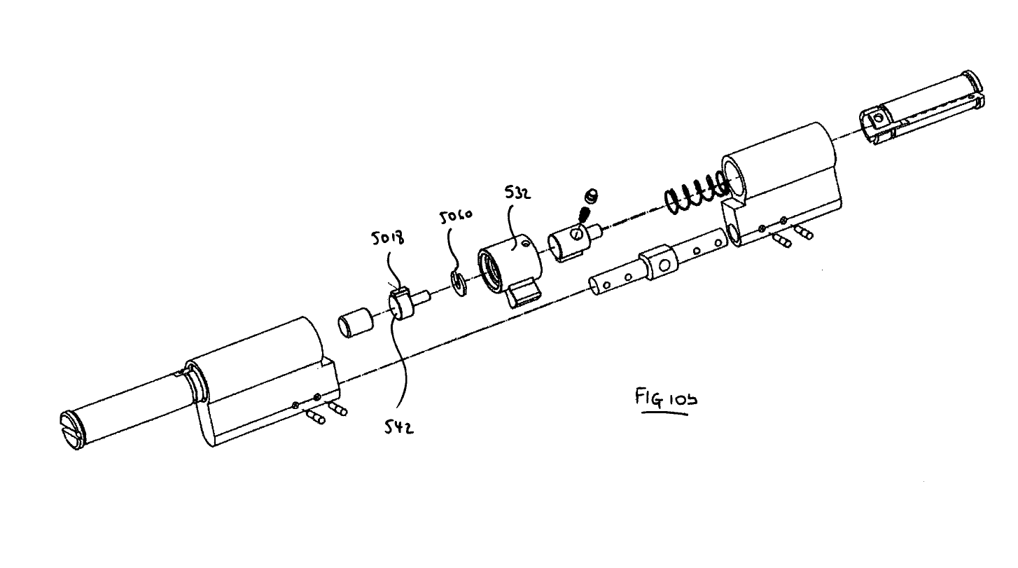

FIGS. 10a and 10b are exploded perspective views of a fifth lock cylinder in accordance with the present invention.

Referring to FIGS. 1a to 1c, a double lock cylinder 100 is shown installed though the thickness of a closure 10. The closure comprises a locking assembly 50 disposed therein which will be described in more detail below. The closure defines an interior 12 and an exterior 14. The cylinder comprises a first lock actuator assembly 102, a cam assembly 104 and a second lock actuator assembly 106.

The first lock actuator assembly 102, the cam assembly 104 and the second lock actuator assembly 106 are generally cylindrical with radially projecting portions 108, 110, 112 respectively thereby forming a euro-profile lock cylinder 100. Each of the radially projecting portions 108, 110, 112 define axial through bores 114, 116, 118 respectively. Each of the radially projecting portions 108, 112 define transverse through bores 120.

The radially projecting portion 110 of the cam assembly 104 defines a transverse attachment hole 122.

The first lock actuator assembly 102 comprises a first drum 124 defining a keyhole 126. The second lock actuator assembly 106 comprises a second drum 128 defining a further keyhole 130.

The cam assembly 104 comprises a rotatable cam 132 which is generally cylindrical and comprises a radially projecting cam lever 134. It will be understood that the cam lever is always in an extended position (e.g. see FIGS. 1b and 1c) when the cylinder is in a locked condition, regardless of whether a key is present or turned. Therefore the cylinder cannot be removed by axial sliding.

Turning to FIG. 2, The first lock actuator assembly 102 comprises a pin tumbler locking mechanism 136 actuable by a key as known in the art and which will not be described here. A key (not shown) can thereby rotate the first drum 124 upon alignment of a set of tumbler pins 138 with a shear plane 140. The second drum 128 can also be rotated by a key inserted into the keyhole 130 in the same way (the detail of the pin tumbler locking mechanism in the assembly 106 is not shown).

FIG. 2 is shown in section without the cam assembly 104. As can be seen in FIG. 2, a first actuator 142 is positioned in the end of the first lock actuator assembly 102. The first actuator 142 comprises a cylindrical head 144 from which projects a cylindrical shaft 146. A common radially extending plate member 148 extends from both the shaft 146 and the head 144.

Also shown in FIG. 2 is the second lock actuator assembly 106, which comprises a second actuator 150. The second actuator 150 comprises a cylindrical head 152 from which extends a shaft 154. The cylindrical head 152 comprises a pair of diametrically opposed radially extending plate-like lugs 156, 158. The cylindrical head 152 defines a recess 159, the function of which will be described below.

Turning to FIG. 3, the rotatable cam 132 is shown in section. The rotatable cam 132 comprises a through bore 160 defining a first and a second diametrically opposed abutment 162, 164 respectively.

Finally, turning to FIG. 4, the interrelationship between the actuators 142, 150 and the rotatable cam 132 is shown, as will be described below.

The lock cylinder 100 is assembled first by loading the first actuator 142 into the end of the first drum 124 such that it can slide axially but not rotate relative thereto (for example by a keying or spline arrangement). The second actuator 150 is assembled into the second drum 128 in a similar manner but biased away from the second drum 128 by a compression spring 166. A second actuator lock pin is also installed (not shown) which will be described in more detail below.

The second lock actuator mechanism 106 is then aligned axially with the cam assembly 104 such that the second actuator sits within the cam 132. The first lock actuator mechanism 102 is then aligned axially with the cam assembly 104 such that the first actuator sits within the cam 132 as shown in FIG. 4.

The first lock actuator mechanism 102, the cam assembly 104 and the second lock actuator mechanism 106 are then fastened together by passing a pin (not shown) through the now coaxial bores 114, 116, 118 and fastening with rivets through the transverse bores 120.

The entire lock cylinder 100 can then be slid into place in a closure 10 and screwed in place from the side of the closure through the attachment hole 122. Once in position, the cam 132 is aligned within the locking assembly 50 and as such the cam lever 134 is capable of actuating a bolt (not shown) of the closure 10 to unlock or unlatch it.

Once assembled, as can be seen in FIG. 4, the end of the shaft 146 of the first actuator 142 abuts the cylindrical head 152 of the second actuator 150. The first actuator 142 and the second actuator 150 are therefore in abutment such that they can rotate relative to each other but are not mechanically joined. The first actuator 142 and the second actuator 150 form a clutch.

Without a key inserted into the keyhole 126, the first actuator 142 is urged into its leftmost position with respect to the first drum 124 as shown in FIG. 2. The first actuator is urged into this position by abutment with the second actuator 150 which in turn is urged by the spring 166. As can be seen in FIGS. 4 and 5a, the plate-like lugs 156, 158 partially engage the abutments 162, 164 of the cam 132 in this position. As such, rotation of a key in the keyhole 130 rotates the drum 128, which in turn rotates the actuator 150 (as it is keyed or splined to the drum 128 (not shown)) and by virtue of the abutment of the lugs 156, 158 with the abutments 162, 164, the cam can turn to actuate the lock.

This is shown in FIG. 1c in which the keyhole 130 and the cam lever 134 are clearly rotated. It should be noted that the drum 124 does not rotate as the plate member 148 does not engage the abutments 162, 164 of the cam 132.

It should be noted that in this position, the spring 166 is still compressed and constantly applying a force on the second actuator 150.

When the lock cylinder is opened from the exterior 14, a key (not shown) is inserted in a direction D (see FIG. 5b). As such, the first actuator 142 and second actuator 150 are urged to the right against the bias of the spring 166 to compress it further. As this occurs, the lugs 156, 158 come out of engagement with the abutments 162, 164 and the plate 148 engages with the lug 164. This engagement forms a load path between the first drum 124 and the cam 132. As such, providing the correct key in inserted to depress the tumbler pins 138 to the shear plane 140, the lock can be opened as shown in FIG. 1b. Note that the drum 128 and the keyhole 130 do not move as the second drum 128 is not engaged with the cam 132 any longer.

Removal of the key then allows the spring 166 to urge the actuators 142, 150 to the position shown in FIGS. 4 and 5a.

Attempted forced entry into the closure 10 may result in forced removal of the first lock actuator assembly 102 (for example by leverage using a screwdriver, mole grips, wrench or similar). When this occurs, the lock cylinder 100 naturally breaks at a line of weakness 103 (see FIG. 1a) between the first lock actuator assembly 102 and the cam assembly 104. The line of weakness 103 may be provided by an assembly line between the first actuator 102 and the cam assembly 104 or by a weakening (e.g. a scoring) of the material in this region.

When this occurs, the first actuator 142 will be free to fall from the cam 132, and indeed will be pushed away by the movement of the second actuator 150 under the bias of the spring 166 (see FIG. 5c). When this occurs, the spring will move the second actuator 150 into full engagement with the lugs 162, 164.

Once in this position, the aforementioned second actuator lock pin engages with the recess 159 of the second actuator 150 to lock it in position.

It will be noted that in this, third, configuration of the second actuator 150:
a dimension A between the leading edge of the second actuator 150 (i.e. where it abuts the abutment 162) and the end of the cam 132 proximate the second lock actuator assembly 106, is greater than:
a dimension B between the leading edge of the lever 134 and the edge of the cam 132 nearest the first lock actuator assembly 102.

This allows the cam to remain in position, and prevents rotation (other than that about the main, intended rotation axis) of the cam. In other words, the main rotational axis X (see FIG. 4) cannot be rotated itself once the cam is in situ. As such, the cam cannot be easily wrenched from the installed position when connected to at least one of the actuator assemblies 102, 106.

The configuration and operation of a lock pin assembly 170 is shown in FIGS. 6a to 6c.

The lock pin assembly 170 comprises a pin 172 slidable within a blind bore 174 and outwardly biased by a pin spring 176. Three positions of the second actuator 150 are shown in FIGS. 6a to 6c. The three positions correspond to those of FIGS. 5a to 5c. As can be seen in FIGS. 6a and 6b, the pin 172 generally rides along the outer surface of the cylindrical portion 152 until the condition of FIG. 5c is achieved (i.e. the first actuator is removed). At this point, the pin 172 engages with the recess 159 and prevents further movement of the second actuator 150.

In this way, the second actuator 150 is held in position and cannot be removed from the remainder of the lock cylinder 100 when fitted in the locking assembly 50. This makes actuation of the lock extremely difficult and inhibits forced entry into the closure 10. It should be noted that a load path still exists between the second drum 128 and the cam 132, allowing actuation of the lock by a key in the keyhole 130.

This allows the closure to be opened by an authorised user (who has entered by an alternative closure) to remove and repair the lock cylinder 100 when fitted in a lock assembly.

An alternative, preferable arrangement is shown in FIGS. 7a to 7c. Reference numerals of similar components are shown 100 greater than the lock cylinder 100.

A second actuator 250 is shown in three positions in FIGS. 7a to 7c corresponding to those of FIGS. 6a to 6c. The lock pin assembly 270 is provided within the second actuator 250. The bore 259 is provided within the drum 228 into which the pin 272 of the lock pin assembly 270 can move once the condition equivalent to FIG. 5c is achieved (i.e. the first actuator is removed). It will be appreciated that this system works in a similar way to that of the lock cylinder 100, however the pin 272 and the bore 259 are provided on different components.

Turning to FIGS. 8a and 8b, a lock cylinder 300 is shown. All similar features to the lock cylinder 100 are numbered 200 greater. The main differences between the cylinder 100 and the cylinder 300 are as follows.

A fixing boss 3002 is provided, which comprises a centre portion 3004, a first shaft 3006 and a second shaft 3008. The centre portion 3002 defines a transverse attachment hole 322 similar to the attachment hole 122. Each of the shafts 3006, 3008 define transverse bores 3010 which correspond to the transverse bores 320 on the first and second lock actuator assemblies 302, 306. This facilitates assembly of the lock cylinder 300 with pins 3012.

The fixing boss 3002 comprises an undercut portion 3012 between the centre portion 3004 and the first shaft 3006 which provides local weakening. Therefore, if the lock cylinder 300 is attached from the first actuator assembly 302 side, failure will occur at the undercut 3012 leaving the centre portion 3004 and the second shaft 3008 intact with the second actuator assembly 306.

It will be seen that a lock pin assembly 370 is provided in the second actuator 350 per the arrangement of FIGS. 7a to 7c. The pin 372 is engageable with a bore 359 in the second drum 328 once the second actuator has been urged to a condition equivalent to that of FIG. 7c (i.e. if the first actuator assembly 302 is removed).

The cam 332 is similar to the cam 132 except that it comprises a bulkhead wall 3014 separating the first actuator 342 and the second actuator 350. The bulkhead wall defines a through-bore 3016 for the cylindrical shaft 346 of the first actuator 342. With that exception, the bulkhead wall is solid.

The first actuator 342 comprises a radial lug 3018 projecting therefrom which engages with a blind groove (not shown) on the bulkhead wall 3014. Similarly, the second actuator 350 comprises a radial lug 3020 which engages with a blind groove on the opposite side of the bulkhead wall 3014. It will be noted that the rotational engagement formations (lugs 3018, 3020) between the actuators 342, 350 and the cam 332 are not coincident such that the blind grooves can be made without significant weakening of the bulkhead wall 3014. In this case, the grooves for the lugs 3018, 3020 are substantially diametrically opposed.

If the first actuator assembly 302 is removed, and the second actuator 350 moves to a position in which the lock pin 372 engages the bore 359 (i.e. the third condition), the lock pin may be released by inserting an appropriate tool into an access bore 3022 in the cam 332. This may occur during manufacture and assembly.

Turning to FIGS. 9a and 9b, a lock cylinder 400 is shown. All similar features to the lock cylinder 300 are numbered 100 greater. The main differences between the cylinder 300 and the cylinder 400 are as follows.

A blind bore 4050 is defined axially within the second actuator 450. A pin 4052 is inserted into the blind bore 4050 and attached therein (for example by interference). The shaft 446 of the first actuator 442 normally abuts the pin 4052 when the first actuator assembly 402 is present. When the first actuator assembly 402 is removed, the pin 402 can enter the bore 4016 of the cam 432. The pin 4052 is of a length sufficient to be flush with, or protrude from, the bulkhead 4014 when the second actuator 450 is in the third condition (i.e. once the first actuator assembly 402 has been removed).

The pin 4052 is constructed from a hardened material, resistant to machine tools such as drills. This therefore makes it difficult for the lock cylinder 400, and in particular the cam 432 to be damaged by such tools once the first actuator assembly 402 has been removed.

Turning to FIGS. 10a and 10b, a lock cylinder 500 is shown. All similar features to the lock cylinder 300 are numbered 200 greater. The main differences between the cylinder 300 and the cylinder 500 are as follows.

A circular plate 5060 is provided adjacent the bulkhead 5014 of the cam 532. The plate comprises a notch 5062 aligned with the blind groove (not shown) in the bulkhead 5014 which receives the lug 5018 of the first actuator 542. The plate 5060 is secured to the cam 532 by crimping, adhering or otherwise attaching in place.

The plate 5060 is constructed from a hardened material, resistant to machine tools such as drills. This therefore makes it difficult for the lock cylinder 500, and in particular the cam 532 to be damaged by such tools once the first actuator assembly 502 has been removed.

Variations of the above embodiment fall within the scope of the present invention.

The keyhole 130 and corresponding second lock actuator assembly 106 may be replaced by a thumb-bolt.

The cylinders and cam may be attached by any known method other than the riveted pin.

Other cam 132 dimensions are possible, as long as it is of sufficient width to span the thickness of the locking assembly 50.

The above embodiment is shown with the first actuator 142 having a single engagement surface on the plate member 148 and the second actuator 150 having a pair of opposed abutments 156, 158. Any number of abutments may be used to transfer the torque from the actuators to the cam. Additionally, any known mechanical interface may be used e.g. a splined or frictional interface.

Any known locking method may be used in place of the sprung pin 172. For example a circlip spring may engage with an annular groove on the clutch to retain it. Alternatively the sprung pin may be provided on the clutch. Alternatively more than one method may be used in conjunction (e.g. two sprung pins or a sprung pin and a circlip).

As an alternative to the aforementioned relationship between dimensions A and B, the cam lever 134 may be made as wide as possible; preferably as wide as the lock assembly 50 in order to inhibit movement off axis X.

1. A cylinder lock comprising:
a lock mechanism,
a lock cam actuable to unlock the lock mechanism,
a first lock actuator assembly positioned on a first side of the lock cam,
a second lock actuator assembly positioned on a second side of the lock cam, the second side being substantially opposite the first side,
a clutch defining an axis, the clutch being movable along the axis between:
a first condition in which the clutch provides a rotational force path from the first actuator to the lock cam to lock or unlock the lock mechanism,
a second condition in which the clutch provides a rotational force path from the second actuator to the lock cam to lock or unlock the lock mechanism, and
a third condition in which the clutch is not movable along the axis, and
further comprising a security mechanism configured to put the clutch into the third condition upon removal of a component of the lock mechanism.

2. A cylinder lock according to claim 1 in which the component is the first lock actuator assembly.

3. A cylinder lock according to claim 1 comprising a resilient member arranged to bias the clutch towards the third condition, in which the component has an operative position in which it is intact with the lock mechanism and when in such operative position forms an abutment which constrains the clutch from moving to the third condition.

4. A cylinder lock according to claim 1 in which the clutch comprises a first actuator of the first actuator assembly and a second actuator of the second actuator assembly, in which removal of the first actuator actuates the clutch to move to the third condition.

5. A cylinder lock according to claim 4 in which the first and second actuator abut and the second actuator is biased towards the first actuator into the second condition, such that removal of the first actuator allows the second actuator to move to an overtravel position representing the third condition.

6. A cylinder lock according to claim 5 in which in the third condition the clutch is rendered immobile along the axis by a mechanical locking mechanism.

7. A cylinder lock according to claim 6 in which the mechanical locking mechanism comprises a resiliently biased member arranged to engage the second actuator when the second actuator is in the overtravel position.

8. A cylinder lock according to claim 1 in which in the third condition, the clutch provides a force path from the second actuator to the cam to lock or unlock the lock mechanism.

9. A cylinder lock according to claim 1 in which an anti-drill component is provided on at least one of the cam and clutch and is configured to be at least partially exposed upon removal of the component of the lock mechanism.

10. A cylinder lock according to claim 9 in which the anti-drill component comprises a pin mounted to the clutch and aligned with the axis.

11. A cylinder lock according to claim 10 in which in the third condition the pin penetrates the cam to be exposed to a first lock actuator side of the cam.

12. A cylinder lock according to claim 9 in which the anti-drill component comprises a plate attached to a first lock actuator side of the cam.

13. A cylinder lock according to claim 9 in which the anti-drill component comprises a hardened steel component.

14. A lock assembly according to claim 1 in which the lock cam comprises:
a radially projecting cam lever, and,
wherein a distance between the interior abutment surface and the second side of the lock cam is greater than a distance between the first side of the lock cam and the radially projecting cam lever.

15. A lock assembly according to claim 14 in which a width of the cam lever is substantially equal to a width of the locking mechanism interior such that a rotational degree of freedom of the main axis is reduced.

16. A lock assembly according to claim 14 in which the width of the lock cam is 1 to 8 mm less than the width of the locking mechanism interior.

17. A cylinder lock comprising:
a lock cam assembly comprising a lock cam actuable to lock or unlock a lock mechanism,
a first lock actuator assembly positioned on a first side of the lock cam,
a second lock actuator assembly positioned on a second side of the lock cam, the second side being substantially opposite the first side,
in which a weakened area of the cylinder lock is defined on, or on the first lock actuator side of, an interface between the first lock actuator and the lock cam.

18. A cylinder lock according to claim 17 in which the weakened area comprises a locally thinned or scored section of material.

19. A cylinder lock according to claim 17 comprising a fastener arranged to fasten the first lock actuator assembly to the lock cam assembly, in which the weakened area is defined on the fastener.

20. A cylinder lock according to claim 17 comprising a fastener comprising:
a first actuator mounting arm for attachment to the first lock actuator,
a second actuator mounting arm for attachment to the second lock actuator,
a central mounting portion for attachment of the cylinder lock to a lock mechanism,
wherein the weakened area is defined on the fastener between the first actuator mounting arm and the central mounting portion.

21. A cylinder lock according to claim 17 in which the weakened area comprises an interface between two components of an assembly.
